(19) United States
(12) Patent Application Publication
(10) Pub. No.: US 2004/0231562 A1
(43) Pub. Date: Nov. 25, 2004

(54) Gelled carrier composition for surface colorants and associated methods of use

(75) Inventor: Daniel L. Doolan, Mesa, AZ (US)

Correspondence Address: Daniel L. Doolan, Tamryn R. Doolan, Surface GelTek, LLC, 8201 E. Highland Avenue, Scottsdale, AZ, 85251, US

(73) Assignee: Surface GelTek, LLC

(21) Appl. No.: 10/767,560

(22) Filed: Jan. 28, 2004

Related U.S. Application Data
(60) Provisional application No. 60/444,342, filed on Jan. 30, 2003.

(51) Int. Cl. C08L 5/00

(52) U.S. Cl. 106/499; 106/146.1

(57) ABSTRACT

The present disclosure provides a decorative stain and/or coating composition which can be applied, using conventional, low-cost techniques to concrete, masonry or like material surfaces in order to provide an desired aesthetic appearance to such surfaces. The methods of use taught herein do not require expensive and laborious pre-treatment, such as cleaning and restoration, as well as handling/disposal concerns typically associated with acid-utilizing stains and decorative coatings and sealers.

### RELATED APPLICATIONS

This application claims benefit of and priority to U.S. Provisional Application Ser. No. 60/444,342, filed on Jan. 30, 2003 and entitled “A GELLED CARRIER COMPOSITION FOR SURFACE COLORANTS AND ASSOCIATED METHODS OF USE”, the disclosure of which is herein incorporated by reference in its entirety.

### BACKGROUND

1. Field of the Invention

This invention relates to a composition that is a carrier for various colorants, such as pigments. More particularly, the present invention relates to gelled carriers of porous surface colorants.

2. Description of the Background Art

The vast majority of decorative stains available and commercially known in the prior art and being of the type used on concrete, masonry and similar surfaces have been composed of pigments along with some type of applicable carrier base such as water or solvent.

If desired, an antique, variegated, decorative, informative, or artistic or any combination thereof, effect is established on such surfaces by using suitable colors applied to simulate the qualities and/or overall aesthetic appearance desired. A variation of color tone may be accomplished from applications of pigmented washes. Such appearances are common throughout the Mediterranean regions of the world and are now widely imitated architectural coatings. Conventional paints and stains may be applied to provide tones or color(s) over concrete, masonry or like surface.

In some instances, for example in new concrete compositions, the use of an intrinsic color for cements is incorporated. However, in order to accomplish this, the mixing of color and the cleaning up of concrete mixers is necessary, along with considerable labor and expense.

Concrete and like materials are produced from the alkaline earth materials and metals. Concrete is typically produced by mixing calcium hydroxide (slaked lime) with sand, gravel, and water. As the water evaporates, the calcium, hydroxide reacts with the carbon dioxide in the air forming calcium carbonate and the mixture hardens into solid material. The calcium carbonate in the mixture is insoluble in water but reacts readily with most acids.

Conventional acid based stains have been around for a long time and come in a premixed, ready-to-use format with a limited color range. However, the presence of the various acids utilized necessitates associated precautions regarding handling, disposal and associated concerns.

In view of the above, there is still a need in the architectural industry for a decorative stain and/or coating composition which can be applied, using conventional, low-cost techniques to concrete, masonry or like material surfaces in order to provide an aesthetic appearance to such surfaces which is remarkably effective at enhancing the appearance of such materials without the necessity of expensive and laborious pre-treatment, such as cleaning and restoration, as well as handling/disposal concerns typically associated with acid-utilizing stains and decorative coatings and sealers.

### SUMMARY OF THE INVENTION

Therefore, one object of the present invention is to provide for a non-acid/acid free composition for carrying colorants, such as pigments, dyes, inks, stains and the like. The composition may be comprised, based upon percentages by weight of the total weight of the composition, from about 5% to about 30% by weight of a lubricant; from about 3% to about 16% by weight of a gelling agent; and from about 35% to about 85% by weight of water. In some embodiments the composition may also further be comprised of retardant and/or deflocculant.

According to various methods of use and applications, various embodiments of the present invention may have a viscosity of about 1.73 to about 3,200,000 centipoise (cP) or greater.

In particular embodiments, the colorants may be, but not limited to, at least one of mineral colors (such as the exemplary colors of Table 1), pigments, dyes, inks, stains as known in the art. Advantageously, the composition, according to the teachings of the invention, provides a carrier that is amendable to carrying different types of colorants, as previously mentioned.

TABLE 1
Color Index No.

| | |
|---|---|
| PY3 | stable di-arylide = Yellow Lemon opaque on barium sulfate, |
| | Gamboge, Indian Yellow |
| PY83 | stable di-arylide = Yellow Deep, Madder Lake, Alizarin |
| | Crimson, Italian Brown Pink Lake |
| PY83 | stable di-arylide HR = Indian Yellow |
| PY153 | dioxine nickel complex = Indian Yellow Golden & Brown, |
| | Gamboge, Indian Red Gold, Sap Green, Indian Yellow Green |
| PO69 | isiondolin = Yellow, Orange |
| PR 260 | isoindolin = Indian Yellow Golden, Vermilion to Red Scarlet |
| | dual-toned |
| PY129 | methin copper complex = Golden Green, Indian Yellow Green |
| | with PY153 |
| PR101 | synthetic iron oxide = Translucent Yellow to Brown |

In particular embodiments, dry pigments are added directly to the composition or liquefied to the desired diluted color and consistency and then added to the composition, then subsequently applied to dry surfaces, such as concrete. Various formulation(s) will determine how much of a liquefied colorant may be added to the composition before loosing the composition's gel state, the viscosity and/or color defined according to the surface upon which the composition is to be applied (horizontal, vertical, inverted, sloped, surface type . . . etc) and the desired application time, for example.

In still other embodiments, the composition, according to the teachings of the present invention, is further comprised of retardant and/or preservative.

The present invention also provides methods for imparting a hue or hues to a surface by applying the herein disclosed composition, having a colorant, onto a surface for a time sufficient to impart the desired color and/or effect to the surface and subsequently removing the composition from said surface, thus leaving the desired color on the surface.

According to other embodiments, a viscous or gelled fluid composition for carrying mineral colors, stains and other colorants is provided which is applied to surfaces, the composition comprising a lubricant, a gelling agent such as gelatin or silicon dioxide or mixtures thereof, and water in an amount less than about 85% by weight of the composition. Optional other ingredients may be added to the composition. A particular embodiment of the invention is a composition comprising from about 15% to about 30% by weight of a lubricant such as glycerin or mineral oil, from about 3% to about 16% by weight of a gelling/thickening agent such as gelatin or silicon dioxide or mixtures thereof, from about 35% to about 85% parts by weight of water and from about 0.1% to 2.5% by weight of retardant, such as biocides and/or antimicrobials, for example.

The foregoing and other objects, features and advantages of the present invention will be apparent to those of skill in the art from the following detailed description. Other aspects and advantages of the invention will become apparent to those in the art from the following detailed description, illustrating by way of example the principles of the invention.

### DESCRIPTION OF THE PREFERRED EMBODIMENT

Reference will now be made to exemplary embodiments of the present invention. It is to be understood that other embodiments may be utilized and compositional and functional changes may be made without departing from the respective scope of the present invention.

The carrying composition, made in accordance with the teachings of the present invention, is unique from the standpoint of carrying colorant effectiveness, user's complete control of color placement, broad applicability, ease of manufacture, ease of application, safety and environmental containment.

A first component may be either gelatin or silicon dioxide, or mixtures thereof, as a thickening agent. These substances are both soluble and stable in high acid media. Colloidal silicon dioxide (SiO₂) is the preferred thickening agent. An example of this colloidal silicon dioxide is sold under the trademark CAB-O-SIL M5, a fumed silicone dioxide. This material is very stable in high acid media, does not change pH of the final composition and can be used in comparatively small proportions. Gelatin, also known as a hydrocolloid, is also useful as the thickening agent. It is a complex protein compound obtained from boiling of animal tissue in water. It is soluble in glycerin and HCl and absorbs about 5 to 10 times its weight of liquid and swells and softens when immersed in water. Typically, the amount of thickening agent used will range from about 3% to about 16% by weight of the total composition. A preferred range is about 10% to about 16% parts by weight.

In order to provide fluidity and viscosity desired to practice the invention, the final composition will generally have a viscosity between about 1.73 and about 3,200,000 centipoise (cP) (or even greater), depending on the type of pigment added to the composition. CAB-O-SIL M5 and gelatin can be used at very low concentrations to produce the desired viscosity and fluidity and have especially good acid stability and wetting characteristics, providing the present compositions with outstanding resistance to dispersion in water. These compositions should have a pH ranging from about 5.0 to about 9.0.

The use of dispersing agents or deflocculants, often referred to as stearic suspension media or repulsion surfactants, can be useful in some of the more fluid compositions. When colloidal silicon dioxide is used, there is an issue concerning the size and consistency of particles and their ability to be placed into stable suspension. Optimum size is considered to be between about 0.3 to about 0.5 microns. However, if the solution does not remain stable, it is necessary to utilize one or more of the following exemplary dispersing agents or deflocculants: Sodium silicate, hydroxypropyl cellulose, ethanol, methanol and butanol. Other comparable products in the same category with similar properties will also be suitable, for example Disperbyk-190 (a dispersant having modified polymers utilized as a wetting/dispersing additive) & BYK-155 (a dispersant comprising sodium salt of an acrylate copolymer). The amount of dispersing agent or deflocculant to be used is approximately about 0.1% to 4.0% by weight or less.

The composition of the present invention contains at least one lubricant. Exemplary lubricants include glycerin or mineral oil, with glycerin (C₃H₈O₃) being preferred. This component improves both the spreading characteristics of the composition and helps to protect the applicator's skin so that the penetration of the colloidal silicon dioxide into the pores is slowed down and/or reduced and thus increases the safety of handling the composition. It also works in addition to the water as a solvent for the gelling agent and as an emollient providing protection to the skin. Glycerin is neutral to litmus and extremely soluble in acid or water.

In some embodiments, the amount of glycerin employed can be between about 5% to about 40% by weight. A plurality of lubricants may be used in conjunction so long as the total amount does not exceed the maximum parts per weight. The preferred concentration range for the lubricant is about 10% to about 30% by weight.

Other optional components which can be added to contribute specific characteristics or enhance the aesthetic appeal include dyes, fragrances, solvents or enzymes, however, any solvent or enzyme selected must be stable in the final composition.

The invention provides a highly convenient, highly controllable and rapid means for adding acid stains, mineral pigments and other colorants to the gelled composition for application of these colorants to porous surfaces. The composition herein described is applied for example by spraying, squirting, brushing or by application of impregnated cloth or pad onto the porous surface. Once the colorant/s have been added to the composition, and because of its fluidity, viscosity and ability to wet hard surfaces even at lower viscosities, the composition made according to the teachings of the present invention forms a continuous sheet of active material and flows uniformly over the entire applied surface, allowing an extended dwell time to optimize colorant transfer. The composition, when used at higher viscosities such as about 3,200,000 centipoise, for example, has been formed into a gel. In this state, the composition can readily be applied to any vertical, angled or inverted surface without running off. This provides a highly concentrated colorant carrier. After effectively depositing the desired colorant, the composition can be easily rinsed away with water or other diluents. For example, the composition may also be collected via brushing the composition, a gel, into a mass, thus reducing the amount left on the surface. Residual product can be removed via a wet vac system, or other vacuum means, for example.

The following convenient procedure for preparing the composition may be utilized to provide the compositions taught herein. The preferred amount of thickening agents are dissolved into the preferred amount of water and mixed thoroughly, with an impeller system, agitators, hand-mixing (paddle), etc, for example. This can be done at room temperature. Optional ingredients may be added at this time. These ingredients include, but are not limited to, at least one biocide, such as, but not limited to methyl paraben and propyl paraben.

It is a feature of the invention that the manufacture of the composition can be carried out rapidly, at room temperature, without the need for extraordinary conditions or equipment. Because there are no toxic (i.e.; acids) in the shelf ready composition, manufacturing this product does not require additional ventilation or safety gear other than normal manufacturing precautions. For example, protective clothing would not have to be listed, normal room temperature would be acceptable and “extraordinary equipment” would not be required, (i.e.; special Teflon coated equipment for example); there are no associated noise, environmental disposal pollution or other extraordinary conditions associated with the manufacturing of the composition.

Colorant carrying compositions prepared in accordance with this invention are stable in storage and retain their novel characteristics for relatively long periods of time. The compositions are generally packaged in containers which are designed to facilitate their application.

The following non-limiting examples illustrate the practice of certain specific embodiments of the invention. It will be understood that the invention is not limited to the specific materials or proportions given, but comprehends all such modifications and variations thereof as will be apparent to those skilled in the art.

### EXAMPLE 1

An exemplary formulation comprising the following carrier composition was prepared:

10 gram sample of carrier composition comprising:

| COMPONENTS | WEIGHT % | WEIGHT kg |
|---|---|---|
| DI WATER | 79.07 | 149.76 |
| Methyl Paraben | 0.16 | 0.30 |
| BYK-155 | 0.19 | 0.36 |
| Cab-O-Sil | 9.63 | 18.24 |
| Glycerine | 10.56 | 20.00 |
| Acrysol RM-8W | 0.39 | 0.74 |
| Total | 100.00 | 189.40 |

VISCOSITY > 3,200,000 cP
{Acrysol RM-8W is a solvent-free, water based version of Acrysol RM-825 (utilized in Example 2), a nonionic associative thickener supplied as a low viscosity solution, which may be obtained from Chunghan Chem International Ltd}.

To the 10 g sample of carrier composition was added 5 grams of a yellow colorant (2:1 ratio). The yellow colorant utilized in this Example is made by QC Construction Products (QC Color Tech-E Yellow, bottled under QC CEMTINT EXOTIC COLORS—YELLOWS) and is a water based, non-acid, liquid concrete colorant.

Although the color thinned out the gel composition, the composition still retained its gel qualities and was able to remain on a vertical piece of concrete once disposed thereon, without running. By comparison, the yellow colorant applied neat (not blended with the composition taught herein) to a vertical piece of concrete ran down the vertical piece of concrete similarly to the extent that plain water runs.

Certain acid colors, i.e.; lighter colors, will be added at higher concentration than other colors, for example; black is rarely used full strength but amber is rarely diluted, therefore, the amount added to the composition would be controlled by the applicator's desired affects. Non-acid pigments are more vibrant and come pre-liquefied or in powder form. It would be the applicators choice of how much of any given colorant is added for desired effect.

Additional exemplary composition formulations are provided in Examples 2 and 3:

### EXAMPLE 2

| COMPONENTS | WEIGHT % | WEIGHT kg |
|---|---|---|
| DI WATER | 79.31 | 150.00 |
| BYK-155 | 0.20 | 0.38 |
| Cab-O-Sil | 9.65 | 18.25 |
| Glycerine | 10.58 | 20.01 |
| Acrysol RM-825 | 0.26 | 0.49 |
| Total | 100.00 | 189.13 |

VISCOSITY > 3,200,000 cp

### EXAMPLE 3

| COMPONENTS | WEIGHT % | WEIGHT kg |
|---|---|---|
| DI WATER | 80.91 | 130.02 |
| Disperbyk-190 | 1.25 | 2.01 |
| Cab-O-Sil | 5.39 | 8.66 |
| Glycerine | 12.45 | 20.01 |
| Total | 100.00 | 160.70 |

VISCOSITY = 1,509,000 cP

The invention has now been explained with reference to specific embodiments. Other embodiments will be apparent to those of ordinary skill in the art in view of the foregoing description and examples.

1. A composition for carrying colorant comprising from about 5% to about 40% by weight of a lubricant; from about 3% to about 16% by weight of a gelling agent; and from about 35% to about 85% by weight of water.

2. The composition according to claim 1, further comprising a retardant.

3. The composition according to claim 1, wherein the lubricant is a mixture of glycerin and mineral oil.

4. The composition according to claim 1, wherein the lubricant is glycerin.

5. The composition according to claim 1, wherein the lubricant is mineral oil.

6. The composition according to any one of claims 1 to 5, wherein the gelling agent is from about 3% to 16% by weight.

7. The composition according to claim 6, wherein said gelling agent is at least one of gelatin and colloidal silicon dioxide.

8. The composition according to claim any one of claims 1-6, wherein the gelling agent is used in combination with a deflocculant.

9. The composition according to claim 8 wherein the deflocculant is at least one of sodium silicate, hydroxypropyl cellulose, ethanol, methanol, and butanol.

10. The composition according to any one of the previous claims, wherein said composition has a viscosity of about 1.73 to about 3,200,000 centipoise (cP).

11. The composition according to any one of the previous claims, wherein said colorant is at least one of a pigment, dye, mineral colors and acid stain.

12. The composition according to claim 2, wherein said retardant is a biocide.

13. The composition according to claim 12, wherein said biocide is an antimicrobial.

14. The composition according to claim 1, further comprising a preservative.

15. The composition according to claim 3, wherein said mixture further comprises a dispersing agent.

16. The composition according to claim 12, wherein said biocide is at least one of methyl paraben and propyl paraben.

17. A viscous fluid composition for carrying mineral colors, acid stains and other pigments comprising from about 15% to about 30% by weight of glycerin; from 10% to 16% by weight of gelatin; from 35% to 80% by weight of water; and from about 0.1% to about 2.5% by weight of retardant.

18. A process for coloring surfaces comprising adding at least one colorant to the composition of claim 1; applying said composition to said surface for a time sufficient to impart a desired hue, and subsequently removing said composition from said surface.

19. The process according to claim 18, wherein said application comprises at least one of spraying, squirting and brushing onto said surface.
